(19) United States
(12) Patent Application Publication
(10) Pub. No.: US 2002/0142838 A1
(43) Pub. Date: Oct. 3, 2002

(54) Video game controller

(76) Inventor: Robert John Russell, Grandville, MI (US)

Correspondence Address: Waters & Morse, P.C., 400 Ledyard Building, 125 Ottawa, N. W., Grand Rapids, MI, 49503, US

(21) Appl. No.: 09/820,127

(22) Filed: Mar. 28, 2001

(51) Int. Cl. A63F 13/00

(52) U.S. Cl. 463/37; 463/36; 463/38; 463/39

(57) ABSTRACT

A video game controller for a video game operated by a steering wheel type of device comprises a base having an arcuate hand grip on an upper edge and a steering disc rotatably mounted on the front surface of the base adjacent the upper edge, such that the disc can be rotated with the operator's thumbs. The steering disc is connected to a variable output electronic signal generator, preferably a potentiometer, for transmitting a turning signal to a video game in response to rotation of the disc. Other controls, such as controls for acceleration, braking, clutch and gear shifting, are mounted on the back of the base plate and operated with the fingers. An offset weight mounted on the steering mechanism for rotation with the steering disc provides progressive gravitational feedback that urges the steering disc to return to a neutral position after a turn is completed.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The invention relates to an improved video game controller of the type used to simulate a steering wheel of a vehicle and other vehicle controls.

A number of game controllers have been developed for the purpose of controlling vehicle movement in video games. Some controllers employ a steering wheel mounted in a stationary base. Representative patents are Houle U.S. Pat. No. 5,829,745 and Raviv, et al. U.S. Pat. No. 4,932,913. Controllers of this nature are generally quite expensive and take up a good deal of space.

As an alternative to a steering wheel device, there are simpler controllers that are capable of generating directional signals as well as other types of control signals. Chan Design U.S. Pat. No. Des. 431,604; Smith III, et al. U.S. Pat. No. 5,394,168; Ohkubo, et al. U.S. Pat. No. 5,624,117; Hsien U.S. Pat. No. 5,700,194; and Sayler, et al. U.S. Pat. No. 5,923,317 are representative of these types of machines. They typically include a base that can be held in a non-supported position or can rest on a table. Such devices control direction by means of a well-known switch known as a D-switch or D-button, which basically includes a non-rotatable disc or cross-shaped switch wherein direction is indicated by the position on the periphery of the disc or side of the cross that is depressed by the operator. Typically such switches control direction on an X-Y axis. While simpler than a steering wheel, such controls are ineffective at simulating the feel of steering a vehicle.

An object of the present invention is to provide an improved inexpensive game controller that steers like a steering wheel and is appropriate for controlling the direction and other operating features of a vehicle. Another object of the present invention to provide an inexpensive steering wheel return feedback mechanism that urges the steering wheel to return to its neutral position when released. Existing systems that provide such feedback typically require temperamental spring mechanisms that are costly, break easily, and generally are not very realistic.

Some new devices use “force feedback” for controlling the feel of the resistance as the operator turns hard. This force feedback is usually controlled with small electric motors connected to the wheel to give resistance and feedback such as bumps and vibrations to the wheel. Most of these devices used the MIDI channels of the joystick port, which can cause problems with the sound card not producing sound. The devices also are expensive.

### BRIEF SUMMARY OF THE INVENTION

In accordance with the present invention, a controller for a computer video program operated by a steering wheel type of input device comprises a hand held base having a hand grippable portion contoured like a steering wheel and a rotatable steering disc mounted on the base in position for rotation by the thumbs of an operator gripping the base. An electrical control device operated by the steering disc produces a control signal representative of steering wheel position. one aspect of the invention, an offset weight is pivotally mounted on the steering mechanism for movement by the steering disc. The weight provides gravitational feedback and urges the steering disc to return to a neutral position wherein the weight is positioned below its axis of rotation. The weight desirably is mounted on the rear side of the base and can be connected to the steering disc by an arm that is either connected directly to an axle for the steering disc on a rear side of the base or extends through an arcuate slot in the base and is attached to the steering disc or axle on a front side of the base. The latter is preferred.

The electrical control device can comprise a variable output electronic device such as a potentiometer that provides an output signal that varies in relation to the distance that the steering disc is turned.

The controller also desirably includes other video program vehicle controls in the form of switches and potentiometers or the like. These are mounted on the back of the base for controlling other vehicle operations with the fingers, such as acceleration, braking, clutch operation, and gear shift operation.

The present invention provides a realistic game controller with steering wheel action that simulates the operation and feel of a vehicle steering wheel at a fraction of the cost of other existing game controllers. The game controller is durable and small enough to be stored easily when not in use.

These and other features of the present invention will become apparent from the detailed description of the preferred embodiment described in detail below and shown in the appended drawings.

### BRIEF DESCRIPTION OF THE DRAWINGS

FIG. 1 is a pictorial view showing the controller of the present invention in use in controlling a video game.

FIG. 2 is a perspective view of the controller of the present invention, showing the front side of the controller with hands in position to operate the device.

FIG. 3 is a perspective rear view of one embodiment of the controller of the present invention.

FIG. 4 is a front elevational view of the controller of the present invention.

FIG. 5 is a front elevational view of the controller of the present invention, showing hands positioned on the controller.

FIG. 6 is a front elevational view of the embodiment of FIG. 3, with the steering disc partially broken away to show that the weight is mounted on the rear side of the base but is attached at the front side of the base by an arm extending through a slot in the base.

FIG. 7 is a view taken along lines 7-7 of FIG. 6.

FIG. 8 is a view similar to FIG. 7, but showing the removable cover over the weight, an alternative way of attaching the potentiometer to the base, and showing the invention with flush mounted control buttons.

FIG. 9 is a rear elevational view of the controller of FIG. 8.

FIG. 10 is a cross sectional side view of another embodiment of the present invention, wherein the weight and attachment arm are positioned on the rear side of the base plate.

FIG. 11 is a front elevational view of the steering mechanism of FIG. 10.

### DETAILED DESCRIPTION OF THE PREFERRED EMBODIMENT

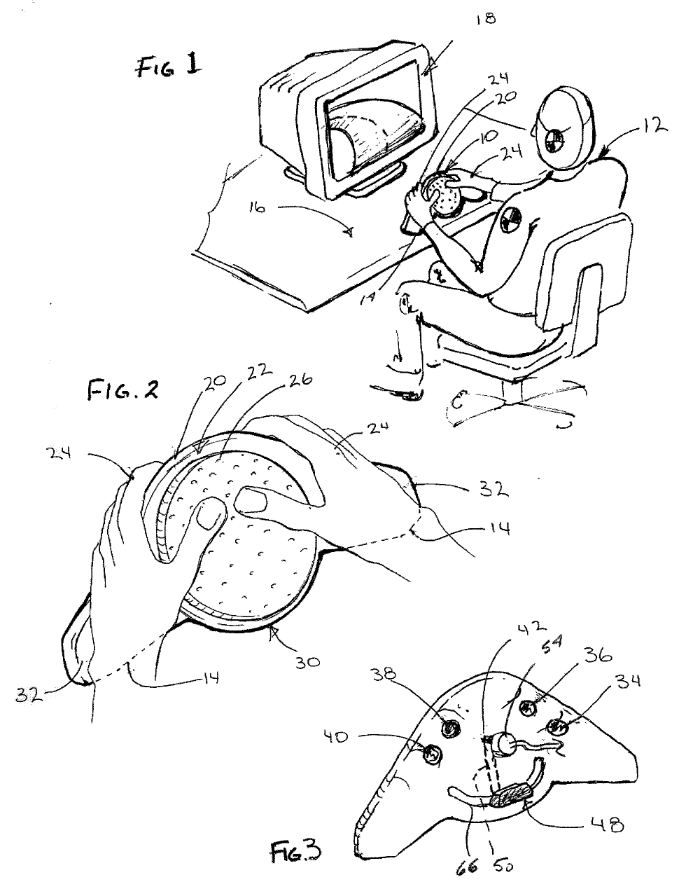

Referring now to the drawings, a handheld controller 10 constructed in accordance with the present invention is shown in FIG. 1 in one possible position of use by a user 12, wherein a bottom edge 14 of the controller base 22 can rest on a table top 16 when playing a video game or operating other video programs displayed on a computer 18. The base desirably is formed in the shape of a base plate, with an upper edge 20 of the base plate being arcuate in shape so as to generally simulate the contour of a steering wheel. The hands 24 of the operator grip the arcuate portion of the upper edge in the manner shown in FIGS. 1 and 2, with the fingers of the hands extending over the back of the base plate and the thumbs of the hands being positioned to control a rotatable steering disc 26 mounted on the front of the base plate. The controller alternatively can be held on one's lap or in the hands alone, without any supporting surface. In either case, the controller is generally held with the disc being in an inclined or non-horizontal position when in the normal operating position.

Base 22 is typically formed of a plastic resin and is shaped for convenient handheld operation by an operator. The base has a generally round center section 30 with downwardly and outwardly extending arms 32 on each side of the center portion. Arms 32 provide an easy hand hold and also provide a stable, non-tipping base when the lower edge of the base 14 is rested against a table, as shown in FIG. 1.

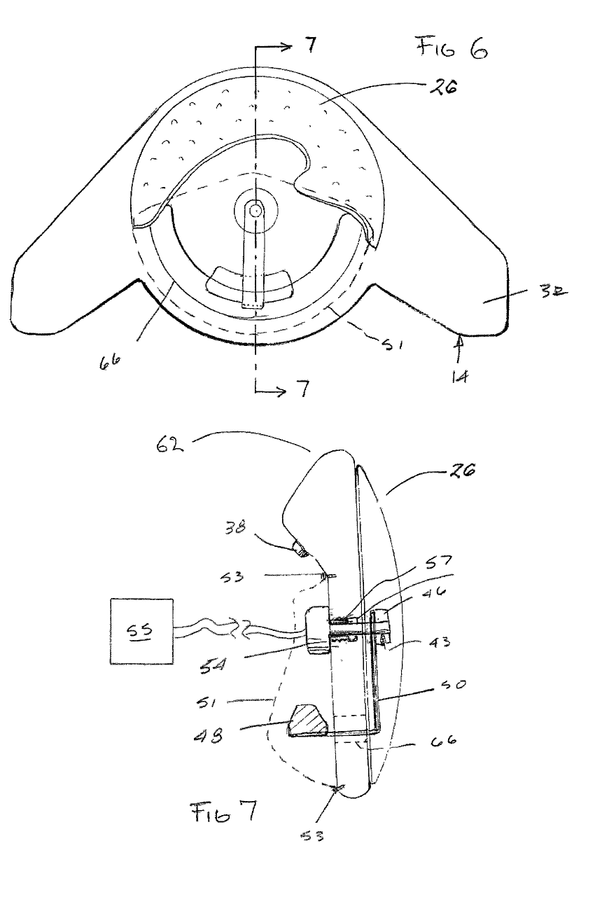

A rotatable disc 26 is mounted on the front of the base plate and is rotated by means of the operator's thumbs, as shown in FIGS. 1, 2, and 5. The disc is desirably rounded like a steering wheel but can be other shapes. The steering disc is mounted on an axle 42 that extends through the base plate.

A potentiometer 54 is mounted on the rear side of the base and has a rotatable output shaft that extends through an opening in the base plate. The potentiometer output shaft desirably serves as the axle for the steering disc. Potentiometer 54 converts the movement of the rotating steering disc into an electronic signal and transmits the electronic signal to the video game 55. The potentiometer causes the generation of a continuously variable signal as the disc is rotated. This variable signal can be converted to a digital signal and utilized by the computer or video game 55 in a conventional manner in order to provide a continuously variable control signal representative of the position of the steering disc and hence the direction that the video vehicle is turned.

The back of the base also can include other switches and controls for controlling a video program vehicle. Controls such as switches or potentiometers 34, 36, 38 and 40 are positioned adjacent the upper arcuate edge on the back side of the base and are spaced apart such that different fingers of the operator's hands can control different buttons. The buttons can control, for example, acceleration, braking, clutch operation, and gear shift operation of a vehicle. The buttons can be raised, flush, or recessed in the back of the base. Alternatively, the buttons for some switches can be toggle type switches, especially when the switch is a potentiometer and is used to control acceleration or the like. The electronic controls are conventional.

There are a number of ways in which the potentiometer 54 can be mounted to the base plate. Potentiometers come in many different sizes and shapes and types, and a number can be satisfactory. A rotary potentiometer is preferred.

To restrict rotation of the potentiometer while the output shaft rotates, potentiometers generally have projections 80 extending out of a rear side thereof. Openings 82 can be provided in the base plate that mate with these projections and prevent the potentiometer from rotating when the output shaft is rotated (FIG.8). If it is necessary to space the potentiometer away from the back of the base, a mounting arm 90 or clamp or other mounting bracket fixed to the base can be used to secure the potentiometer in a fixed position to the base (FIG.10).

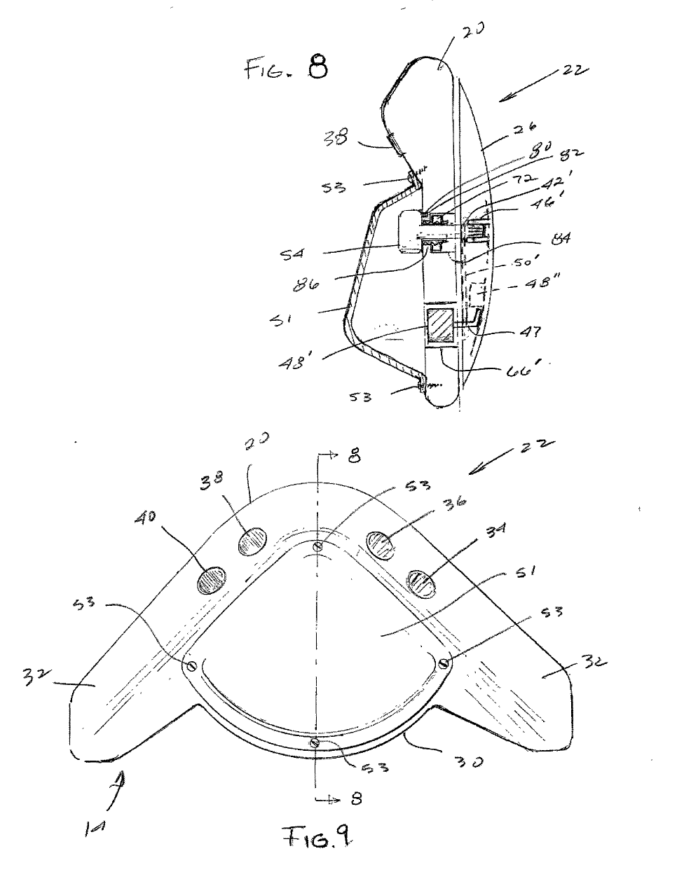

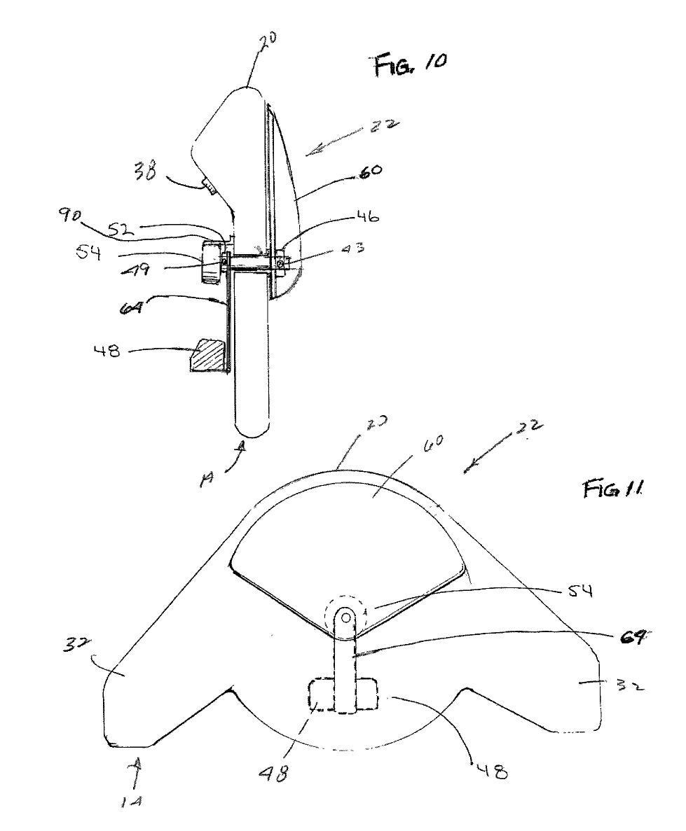

To secure the potentiometer in place, the potentiometer output shaft 42 can be journaled in a mating opening in the base and held in a fully inserted position by a collar 46 and set screw 43 on the front side of the base (FIG. 10). Alternatively, for potentiometers that are manufactured with threaded collars 57 extending outwardly around the output shaft the base plate can be provided with a threaded opening into which the collar can be threaded, as shown in FIG. 7. Alternatively the base plate can be provided with a recessed hole 84, such that a flange 86 is formed at the bottom of the hole (FIG. 8). The threaded collar can extend through the flange and be held in place by a nut 72 threaded on the collar inside the hole (FIG.8).

Steering disc 26 can be attached non-rotatably to the front side of axle 42 by collar 46 which is attached to the steering disc and clamped on the axle by means of a set screw 43 (FIGS. 7 and 10). Alternatively, the end of axle 42′ and the interior of a collar 46′ on the back of the disc (FIG. 8) can be provided with mating ribbed or other non-circular shapes, so that the components are non-rotatably joined.

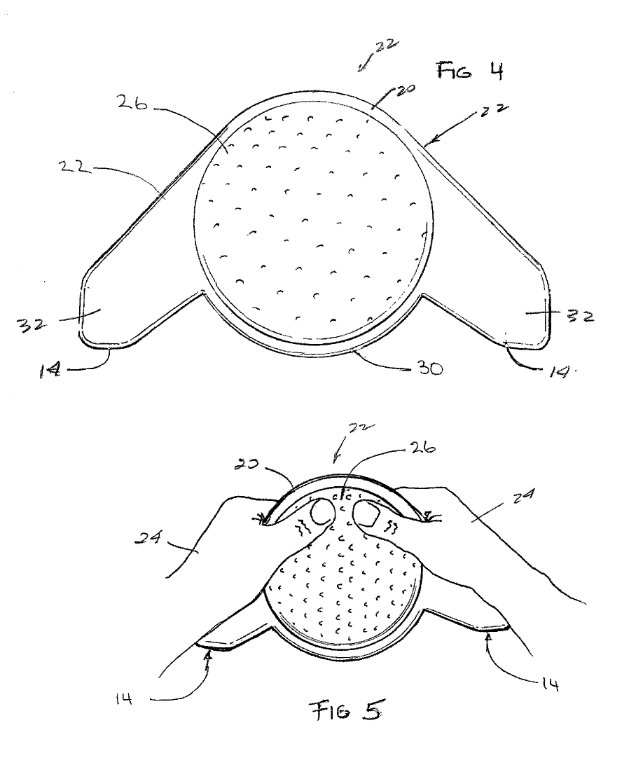

The steering disc is urged to return to a neutral position by an offset weight attached to the disc or axle for rotation with the disc. In the embodiment shown in FIGS. 3, 6 and 7, weight 48 is positioned on the rear side of the base and is attached by a right angle arm 50 to the axle on the front side of the base through an arcuate slot 66 in the plate. This is desired because the weight urges the upper portion of the disc away from a scraping position with respect to the base. A cover 51 is removably attached by screws 53 or the like to the base. In FIG. 8, weight 48′ is mounted at least partially inside arcuate slot 66′ and is attached to the rear side of disc 26 by an arm 47 secured in an offset position to the back of the disc. This makes it possible to use a flatter cover 51 if desired. The weight could be mounted on the rear side or front side of the slot as well and could be shaped flatter or other different shape. The weight of FIG. 8 can be attached to axle 42′ by an arm 50′ (as shown in phantom) instead of to the disc with an arm 47. finally, as shown in phantom in FIG. 8, weight 48″ can be attached directly to the rear side of the disc.

In any case, the weight is offset from the axis of the axle and is positioned so that it is positioned below the axis of the disc when the disc 26 is positioned for operation and centered in its neutral position. Thus, when the disc turns, the weight is lifted to one side or the other. The weight thus urges the wheel to return to its neutral position after it is turned. When the disc is released, the weight restores the disc to its neutral position. Because the leverage on the weight arm increases as the weight rotates from a vertical position toward a horizontal position as the disc is rotated away from its centered position, the weight exerts an increased return force on the disc as the disc is turned further, which is desirable.

A more conventional spring return or other feedback mechanism could functionally be employed instead of the offset weight, but the offset weight is preferred because of cost and durability advantages.

In another aspect of the invention, shown in FIGS. 10 and 11, the offset weight 48 positioned on the back of the base is connected to the axle on the back side of the base by means of an arm 64, which is secured to the axle by a collar 52 by means of a set screw 49 in the collar. Also, in the embodiment shown in FIGS. 10 and 11, steering disc 60 constitutes only a section of a circle. Functionally, the steering disc does not have to be a full circle and does not have to be circular, although an arcuate shape is preferred because the shape simulates a steering wheel. Instead, the disc can be a portion of a circle or other shape covering the area where the operator's thumbs would be placed. The term “steering disc” as used herein is not limited to a complete or partially circular shape. The maximum radial range of motion of the steering disc is selected to be compatible with a comfortable range of thumb movement. A range of movement of 10° or so in either direction is satisfactory. Desirably, the full range of computer program movement can be accomplished without lifting the thumbs from the steering disc.

While the weight is shown attached to the axle or disc in the illustrated embodiments, the weight also could be otherwise mounted for movement with the steering disc, as long as the weight is moved to an unbalanced position when the disc is rotated from its neutral position and urges the wheel back to its neutral position, preferably with increasing force, as the disc is turned further off center.

It is contemplated that the controller of the present invention will be a handheld device approximately 10 inches wide by 6 inches high. The steering disc will be small enough that it can be turned by using the operator's thumbs. The weight, hanging as a pendulum in an offset position, provides a progressive feedback that simulates the feel of a steering wheel at a fraction of the cost of complex feedback arrangements with the additional benefit that such feedback controls are durable and basically non-breakable.

It should be understood that the foregoing is merely representative of the preferred practice of the present invention and that various changes may be made in the arrangements and details of construction of the embodiments disclosed herein without departing from the spirit and scope of the present invention, as defined in the appended claims.

I claim:

1. A computer video program controller for a program operated by a steering wheel type of input device, comprising:
a hand held base having manually grippable portions for engagement of one or more of an operator's hands;
a steering mechanism comprising a steering disc rotatably mounted on the base, the steering disc and grippable portion of the base being positioned such that an operator can rotate the steering disc with one or more thumbs while gripping the base with one or more hands; and
a variable electrical control device operably connected to the steering disc such that the rotational movement of the steering disc can be correlated to a steering control instruction in a computer video program.

2. A controller according to claim 1 wherein the grippable portion is positioned at a peripheral edge of the base, with the grippable portion including hand positions for each hand of an operator, the hand positions being positioned and spaced apart in a manner similar to hand positions on a steering wheel, the steering disc being positioned for thumb access between and adjacent to the hand positions.

3. A controller according to claim 2 wherein the hand positions are located on an arcuate upper edge of a front surface of the base, and the steering disc is mounted adjacent the arcuate upper edge for rotation by thumb action on the front surface of the base.

4. A controller according to claim 1 and further comprising a feedback mechanism that urges the steering disc to return to a neutral position indicative of a straight ahead steering direction when the steering disc is released.

5. A controller according to claim 4 wherein the base is adapted to be held like a steering wheel with the plane of the steering disc being non-horizontal, the feedback mechanism including an offset weight attached for rotation with the steering disc, such that the weight urges the steering disc to return to a neutral position when released.

6. A controller according to claim 5 wherein the steering disc is mounted on an axle mounted in the base, the weight being mounted for rotation with the disc in an offset position with respect to the axis of rotation of the disc.

7. A controller according to claim 6 wherein the axle is rotatably mounted in the base and the steering disc is mounted for rotation with the axle, the weight being mounted for rotation with one of the disc and axle, the electrical control device being mounted in the base so as to be in operational engagement with the axle.

8. A controller according to claim 5 wherein the weight is mounted to the disc at an offset position from the axis of the disc.

9. A controller according to claim 7 wherein the weight is positioned on the rear side of the base and is connected to the disc or the axle on the front side of the plate by means of an arm that extends through an arcuate slot in the base.

10. A controller according to claim 1 wherein the electrical control device comprises a potentiometer non-rotatably mounted on the rear side of the base, the potentiometer having a rotatable output shaft that extends through the base and is non-rotatably connected to the steering disc at a distal end of the shaft.

11. A controller according to claim 5 wherein the weight is positioned at least partially inside an arcuate slot in the base and is connected by an arm directly or indirectly to the steering disc for movement therewith.

12. A video game controller for a video game operated by a steering wheel comprising:
a base plate having a lower edge and having an arcuate upper edge that extends upwardly from the lower edge;
a steering mechanism comprising a steering disc rotatably mounted on a front surface of the base plate, the steering disc being rotatable about an axis generally perpendicular to the base plate, the axis of the steering disc being non-vertical when the game controller is in a normal operating position;
a weight mounted on the steering mechanism for rotation with the steering disc, the weight being mounted at a position offset from the axis of rotation of the steering disc, such that the weight gravitationally urges the steering disc to return toward a neutral position wherein the weight is positioned below the axis; and
a variable output electronic controller device operably connected to the steering mechanism so as to provide an output signal that varies in relation to the radial distance that the steering disc is turned, such that the output signal can be correlated to a directional instruction in the video game;
the game controller being shaped such that an operator grasps the upper edge of the base plate with his hands and controls the rotation of the disc in left and right directions from the neutral position with his thumbs, the weight providing feedback that urges the disk to return to a neutral position when the disc is released, the feedback force of the weight increasing in intensity the further the disk is rotated from its neutral position for at least a rotation distance of ninety degrees (90°) in either direction from the neutral position.

13. A video game controller according to claim 12 wherein the electronic signal control device comprises a potentiometer that causes a variable output signal that varies in proportion to the radial distance that the disc moves from its neutral position.

14. A video game controller according to claim 12 wherein the electronic signal control device produces a substantially continuous output signal representative of the radial distance that the steering disc is turned in both directions from the neutral position.

15. A video game controller according to claim 12 and further comprising a plurality of additional video program controls are mounted on the back of the base plate adjacent the upper edge and positioned such that an operator grasping the upper edge in the manner that one would grasp a steering wheel can operate the vehicle controls with his fingers while operating the steering disc with his thumbs.

16. A video game controller according to claim 15 wherein the additional video program controls are radially spaced along the arcuate upper edge of the base plate such that each of a plurality of switches can be operated by a different finger on the hands.

17. A video game controller according to claim 16 wherein the additional video program controls include at least two controls for each of the left and right hands of an operator.

18. A video game controller according to claim 17 wherein the additional video program controls are representative of vehicle controls for clutch operation, gear selection, acceleration, and braking.

19. A video game controller according to claim 12 wherein the steering disc is mounted on an axle rotatably mounted in the base plate, the axle extending out of front and rear sides of the base plate, the steering disc being mounted on the axle on the front side and the weight being mounted on the axle on the rear side of the base plate.

20. A video game controller according to claim 12 wherein the steering disc is mounted on an axle that is rotatably mounted in the base plate so as to extend from at least the front side of the plate, the disc being mounted on the axle on the front side of the plate, the weight being positioned in an offset position on a rear side of the base plate and being connected to the steering mechanism on a front side of the base plate by an arm that extends from the weight through an arcuate slot in the base plate and then is mounted to the steering mechanism so as to rotate with the steering disc.

21. A video game controller according to claim 12 wherein the base plate has a generally round center portion and stabilizing legs that extend downwardly and outwardly on each side of the center portion, the legs providing a non-rotatable surface for resting the lower edge of the base plate on a table.
